(19) United States
(12) Patent Application Publication
(10) Pub. No.: US 2018/0311802 A1
(43) Pub. Date: Nov. 1, 2018

(54) ATV, SIDE-BY-SIDE, AND SNOWMOBILE UNIVERSAL BALL JOINT REMOVER AND INSTALLER TOOLS AND SERVICE KIT

(71) Applicant: OFF TRACK TOOL CO. LLC, Hancock, MI (US)

(72) Inventor: Ryan E. Kemppainen, Hancock, MI (US)

(21) Appl. No.: 15/958,362

(22) Filed: Apr. 20, 2018

Related U.S. Application Data
(60) Provisional application No. 62/491,440, filed on Apr. 28, 2017.

(51) Int. Cl. B25B 27/00; B25B 27/02; B25B 13/56; B25D 1/16

(52) U.S. Cl. CPC B25B 27/0035; B25D 1/16; B25B 13/56; B25B 27/02

(57) ABSTRACT

A universal ball joint installation and removal tool kit for the purpose of service and repair or removal and installation of ball joint suspension components includes at least one tool assembly comprising a rod member having a first end and a second end, and a plurality of adapter members for mechanical attachment or engagement with respective ones of different sized ball joint suspension components. Each of the adapter members is configured to attach at the second end of the rod member. When servicing a ball joint suspension component, a selected adapter member is mechanically attached to a particular ball joint suspension component and attached at the second end of the rod member, which is used to install or remove the particular ball joint suspension component via a slidable weight along the rod member or pulling or pushing the rod member relative to the particular ball joint suspension component.

### CROSS REFERENCE TO RELATED APPLICATION

The present application claims the filing benefits of U.S. provisional application Ser. No. 62/491,440, filed Apr. 28, 2017, which is hereby incorporated herein by reference in its entirety.

### FIELD OF THE INVENTION

The present invention relates generally to the field of commercial and recreation all-terrain vehicles, side-by-side and multi-passenger commercial and recreational off-road utility vehicles, and snowmobiles where periodic repair and servicing of such vehicles is necessary.

### BACKGROUND OF THE INVENTION

It is generally known that, in the commercial and recreation all-terrain vehicle (ATV), side-by-side and multi-passenger commercial and recreational off-road utility vehicles, and snowmobiles (ATV) industries, periodic and/or unexpected repair and maintenance of ball joint components within vehicle suspension systems is required. Typically, suspension systems of ATV's for example, and in particular ball joint components, are subjected to harsh conditions and heavy use. Typical operating conditions include nearly constant exposure to, for example, water, dirt, mud, dust, snow and ice, while under harsh mechanical service operating conditions, such as rough terrain, impact loads and constant repeated motion cycling.

While ATV engineers and designers do anticipate the environmental and mechanical operating conditions for such expected applications of suspension components that include ball joints, the practical limitations of design and manufacturing cost exist. Multiple design aspects become factors, including, for example, foreseeable use, expected duty cycle, component stress, ease of manufacturing, and product economic cost limitations. These factors may bring about some level of compromise in any given ATV suspension design. As a result, the necessity to remove and replace ball joint components within an ATV suspension system eventually becomes a necessity to sustain the desired level of machine quality, performance, control and continued safe use of the ATV vehicle.

The process of maintenance and repair, and in particular, removing and replacing ATV ball joints, throughout the wide range and various types of ATV vehicles that both have been and are currently being produced can prove to be challenging and often difficult. The various models and styles of products that have been produced for many years by a wide variety of manufactures, has created a significant range of design variation. Many years of product development and evolution has created a variety of unique suspension designs resulting in service and maintenance processes that can also vary considerably. As a result, the ideal methods and tools related to ATV ball joint repair and maintenance can also vary significantly. In many instances, efficient methods and tools simply do not exist and are simply not available to the typical owner of an ATV vehicle.

In many instances, the periodic removal and replacement of ATV ball joints may involve special proprietary service tools, equipment, and procedures that are likely to be made available only to authorized dealers, distributors, and service centers by the particular brand of ATV manufacturer. In these instances, the owner of a particular brand of ATV vehicle is likely to have few, if any, options beyond scheduling suspension ball joint replacement at a manufacture-authorized service repair center or dealer. In these cases, considerable inconvenience may result involving delays in scheduling the next available repair appointment. Additionally, transport of an ATV vehicle rendered practically immovable due to a broken suspension component can sometimes become nearly impossible, especially in remote areas. When special circumstances arise from a remote breakdown and extraordinary transport of a broken ATV vehicle to a repair facility is necessary, excessive inconvenience, time and the relative high cost associated with specialized service, parts and repairs may often be the result.

Optionally, should the ATV owner or non-authorized repair center attempt to replace a worn or failed ball joint themselves by use of improvised tools not specifically intended for such service and repair applications, the result may be often lead to even higher risk and further inconvenience, with the potential for added costs resulting from collateral damage of costly suspension components incurred during the improvised repair process and methods. Similarly, the potential for compromises to various safety aspects related to the ATV vehicle and its repair can also result from the use of poorly improvised tools and repair processes.

While somewhat comparable ball joint repair removal and replacement tools have been and are generally known throughout the history of the automotive repair industry, none ideally specific to the particular special needs of the ATV vehicle industry and markets are currently and readily available to potential customers, including ATV owners, vehicle mechanics and repair centers on the open market. This is particularly true with respect to the typical range of unique sizes, styles, and varieties of the relatively smaller suspension and ball joint components related to ATV vehicles as compared to typically larger and heavier automotive applications.

### SUMMARY OF THE INVENTION

The present invention is related to specialized tools, service tool kits, and improved methods for the removal and replacement of various sizes and unique types of suspension ball joint components utilized within the suspension systems of such vehicles. The specialized tools and service kits described herein are generally directed to a wide and various range of different types sport and utility vehicles within general recreation vehicle industry and similar industry market segments.

The present invention provides an all-terrain vehicle (ATV), side-by-side off-road utility vehicle, and snowmobile universal ball joint remover and installer service kit and tools. The ATV universal ball joint remover and installer kit may comprise various combinations of sub-kits further including selected and specially designed and configured tools for the purposes of removing ATV ball joints from suspension members as well as reinstalling them. The advantages of the kit(s) is provided by the design and construction of a number of specialized tools or adapters that provide the mechanic or user a significant array or range of thread diameter sizes and thread pitch variations to accommodate a majority of anticipated ball joint stud designs and styles that may be encountered during any given ATV or snowmobile suspension repair process involving ball joint assemblies. The anticipated array of tool adapters may be utilized in a variety of different ways depending upon the particular ball joint and suspension component design at hand. The mechanic or user is therefore provided with multiple options to identify the preferred or best method to undertake a particular instance of repair.

For example, from the selection of tools and adapters provided within the kit, the mechanic or user may have the option to undertake ball joint removal and replacement without the need to entirely remove a suspension control arm from the ATV or snowmobile vehicle and bring it to, for example, a workbench, bench vise, special or improvised holding fixture, or hydraulic press, specialized repair facility, or authorized dealer. In this case, considerable time and effort may be saved by the availability and use of a selection of universal ball joint tools within a kit by the ATV owner or mechanic. This can often occur by avoiding the typical need to disassemble and then reassemble the entire suspension system. Preferably, through the use of the present invention, only a minimal number of components or portions of the entire ATV suspension system may need to be removed in order to replace a ball joint.

Optionally, the mechanic or user may elect to utilize the present invention to help expedite the repair process at, for example, a workbench location as desired. Additionally, the relative compact packaging and contents of the universal kit with the specialized tool adapters makes it portable, and therefore possible to accomplish repair and replacement of ATV or snowmobile ball joints at remote sites or off-road locations. A sudden and unexpected breakdown or failure of a suspension ball joint component is most likely to occur off-road or on the trail. In this case, by being prepared and carrying a spare ball joint along with a universal ball joint repair kit, the machine owner-operator can make unexpected repairs where and where they are most likely to occur, such as at a remote location.

With respect to indoor or workshop repairs, the contents of the universal ball joint removal and installation tool kit, including specialized tool adapters, may allow the owner, mechanic or user to identify the best and safest approach for successful repairs. Use of the present invention may readily avoid the necessity of raising the ATV vehicle excessively high off the floor or ground to facilitate repairs. For example, ATV vehicles supported excessively high in the air by use of make-shift methods can pose an increased risk of the vehicle becoming unstable and suddenly tipping or falling. Therefore, use of the present invention can help promote safety when it is necessary to gain access to suspension components during the repair process.

Finally, the contents of the kit(s) including specialized tool adapters promotes ease-of-use and efficient ATV ball joint removal and installation with a greatly decreased risk of potential damage to costly ATV suspension components, which is considerably more likely to occur through the use of improper or improvised tools and methods.

Therefore, the present invention provides an all-terrain vehicle (ATV), side-by-side off-road utility vehicle, and snowmobile universal ball joint tool remover and installer service kit uniquely developed to offer a solution to problems with conventional tools, as well as meet this identified market demand.

These and other objects, advantages, purposes and features of the present invention will become apparent upon review of the following specifications and embodiments in conjunction with the drawings.

### BRIEF DESCRIPTION OF THE DRAWINGS

FIG. 1 is a three-quarter inside upper perspective view of a typical ATV, side-by-side, and snowmobile universal ball joint remover and installer service kit and tools 1 in accordance with an embodiment of the present invention;

FIG. 2 is a perspective view of a first embodiment of the invention as a selection of tools as a kit and example suspension components related to the three-quarter example perspective view of FIG. 1;

FIG. 2A is a three-quarter perspective view of the apparatus of FIG. 2 attached to the example suspension components prior to operation of the tools;

FIG. 3 is a three-quarter perspective view of the apparatus shown in FIG. 2A, and in all examples the user's hands and any optionally supporting surfaces or structures have been omitted for clarity;

FIG. 3A is a detailed view of one end of the view of FIG. 3;

FIG. 3B is a front view of the in-use invention apparatus shown in FIG. 3;

FIG. 3C is a detailed cross-section view of one end of the in-use apparatus of FIG. 3B;

FIG. 4 is a detailed view of another example embodiment showing a portion of the tools and suspension components related to the three-quarter example perspective view of FIG. 1;

FIG. 4A is a front view of the in-use apparatus shown in FIG. 4;

FIG. 4B is a detailed cross-section view of one end of the in-use apparatus of FIG. 4A;

FIG. 5 is a detailed view of another example embodiment, showing a portion of the tools and suspension components related to the three-quarter example perspective view of FIG. 1;

FIG. 5A is a detailed view of one end of the view of FIG. 5;

FIG. 5B is a front view of the in-use apparatus shown in FIG. 5;

FIG. 5C is a detailed cross-section view of one end of the in-use apparatus of FIG. 5B;

FIG. 6 is a perspective view of example universal ball joint adapter shown in FIGS. 1, 2, 5, 5A, 5B, 5C and 7;

FIG. 6A is a perspective view of the bottom of the universal ball joint adapter shown in FIG. 6;

FIG. 6B is a perspective view of the in-use example of the universal ball joint adapter shown in FIG. 6, including engagement with an example ball joint having a threaded stud and hex nut;

FIG. 7 is a detailed view of another example embodiment, showing a portion of tools and suspension components related to the three-quarter example perspective view of FIG. 1;

FIG. 8 is a perspective view of the in-use example of the tools and suspension components shown in FIG. 7;

FIG. 8A is a detailed view of one end of the view of FIG. 8;

FIG. 8B is a front view of the in-use apparatus shown in FIG. 8;

FIG. 8C is a detailed cross-section view of one end of the in-use apparatus of FIG. 8B;

FIG. 9 is a detailed view of another example embodiment, showing a portion of tools and suspension components related to the three-quarter example perspective view of FIG. 1;

FIG. 9A is a detailed view of one end of the view of FIG. 9;

FIG. 9B is a front view of the in-use apparatus shown in FIG. 9;

FIG. 9C is a detailed cross-section view of one end of the in-use apparatus of FIG. 9B;

FIG. 10 is a detailed view of another example embodiment, showing a portion of tools and suspension components related to the three-quarter example perspective view of FIG. 1;

FIG. 10A are detailed views of an example one-piece ball joint install driver shown in FIG. 10;

FIG. 10B are detailed views of an example one-piece ball joint install driver shown in FIG. 10;

FIG. 10C is a lower three-quarter perspective view of the in-use apparatus shown in FIG. 10;

FIG. 10D is a detailed view of the in-use apparatus shown in FIG. 10C;

FIG. 10E is a lower three-quarter perspective view of the in-used apparatus shown in FIG. 10;

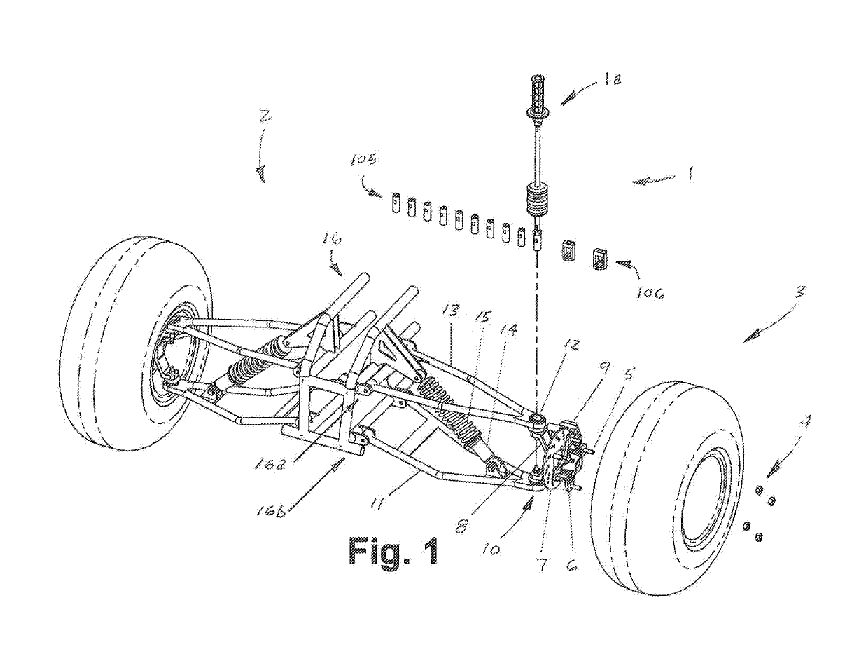

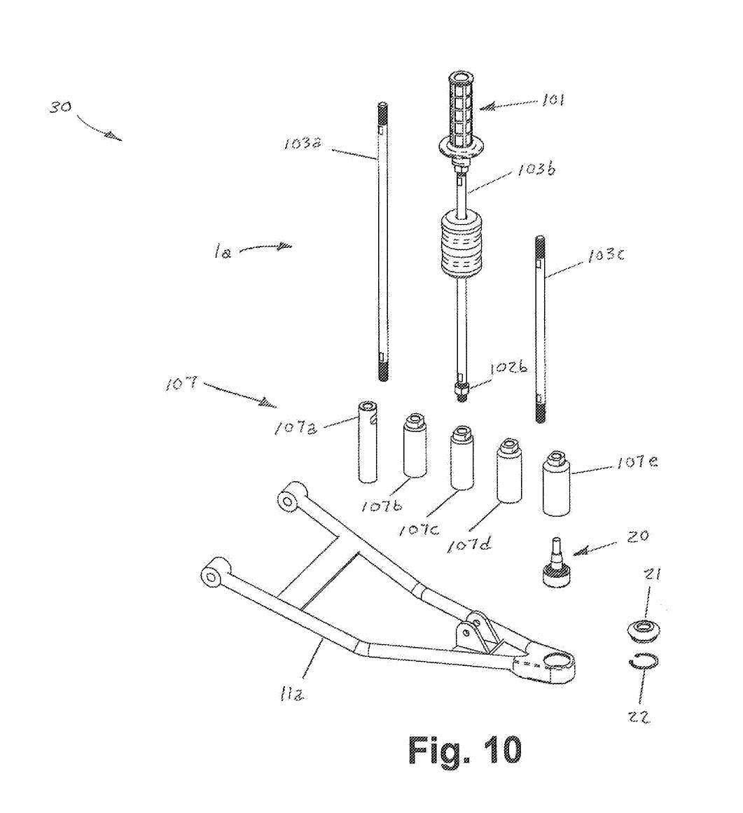

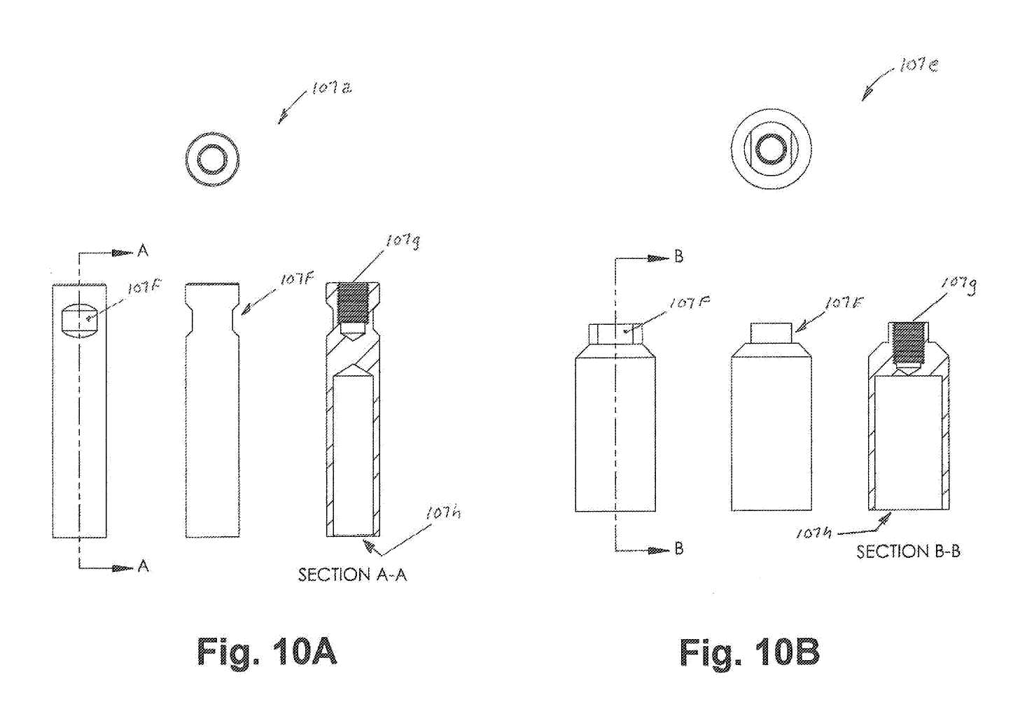

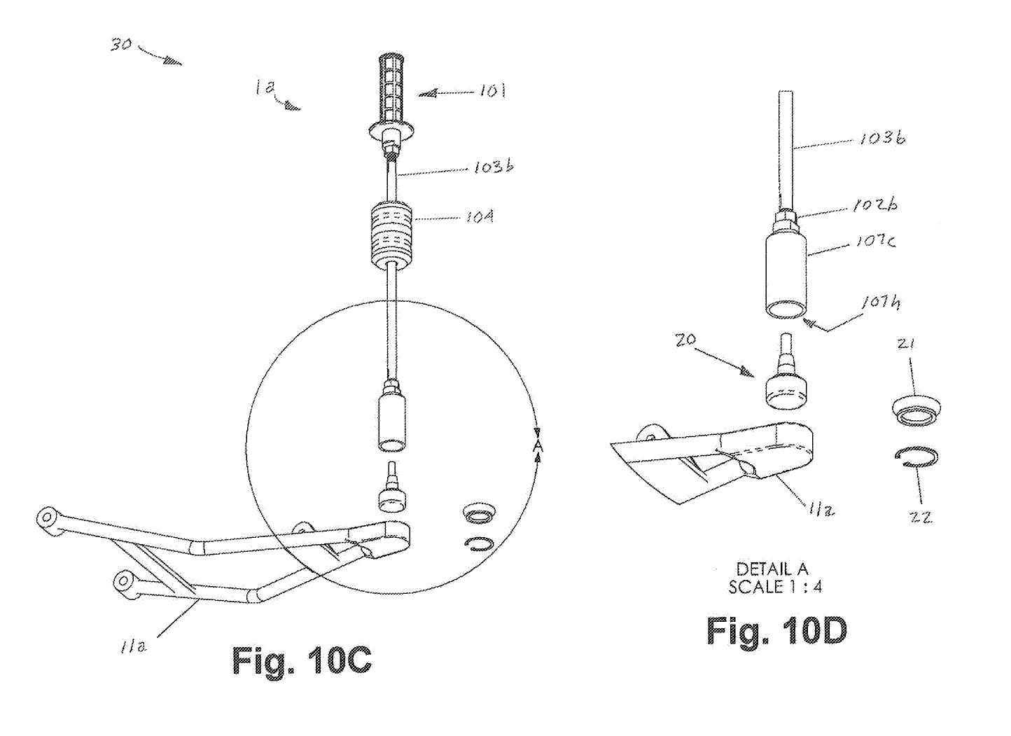

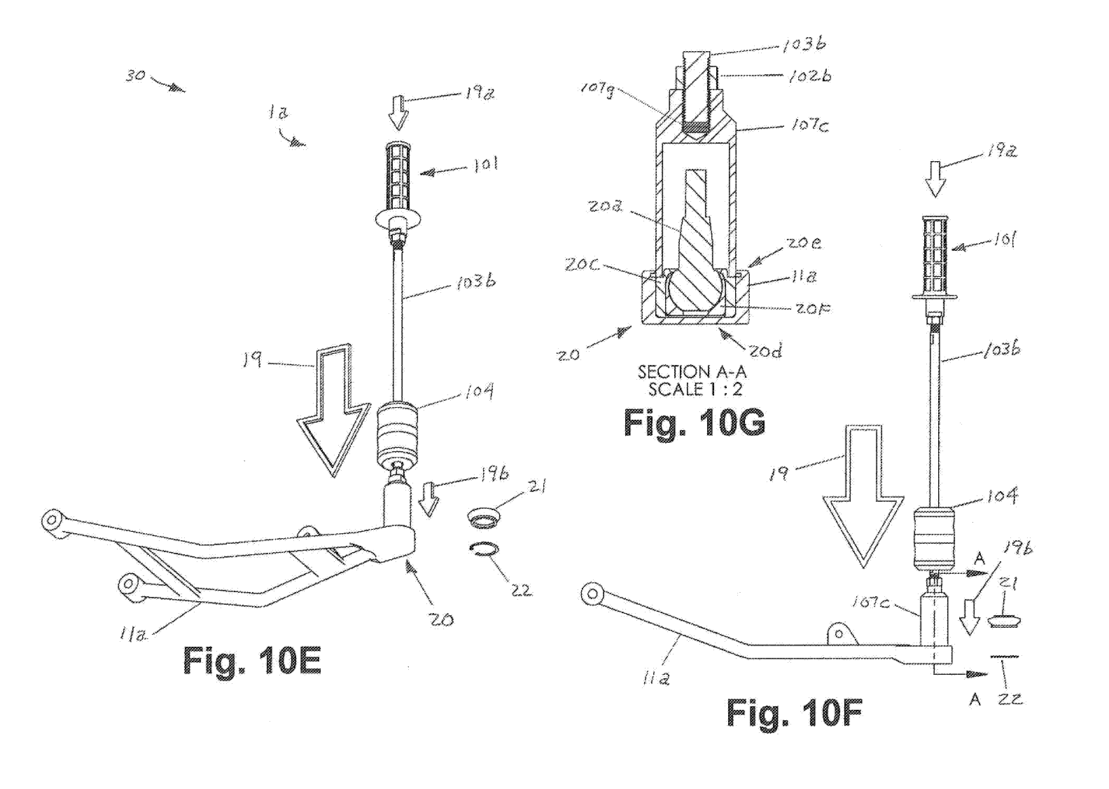

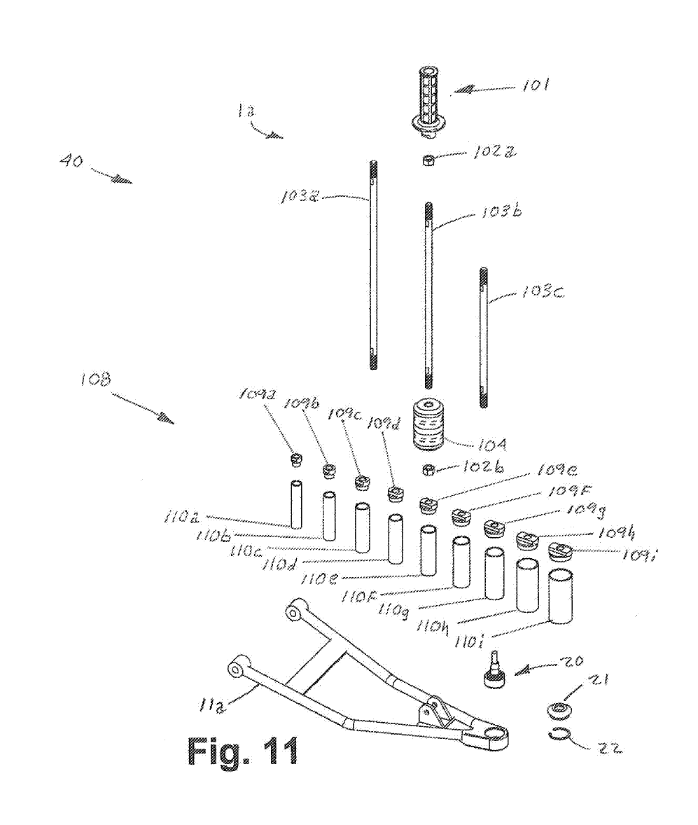

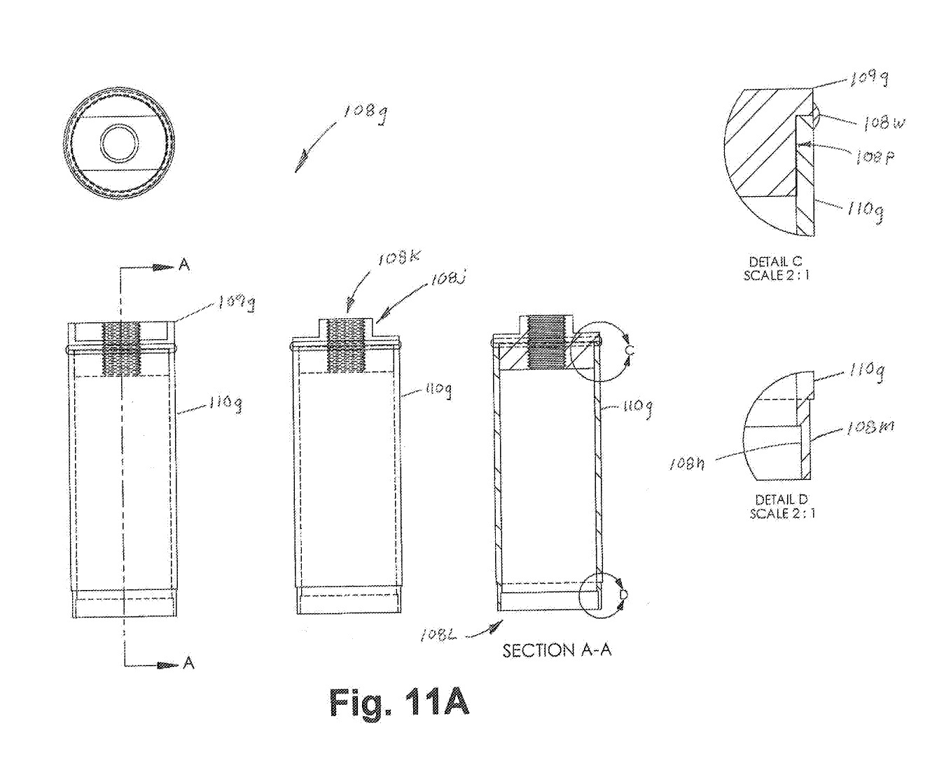

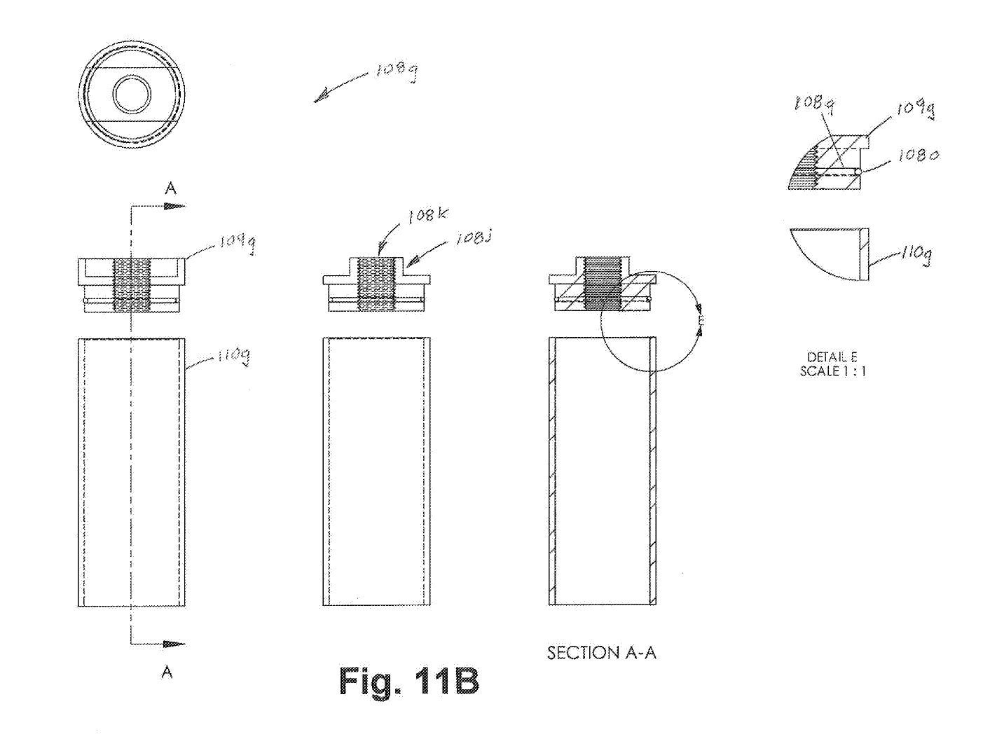

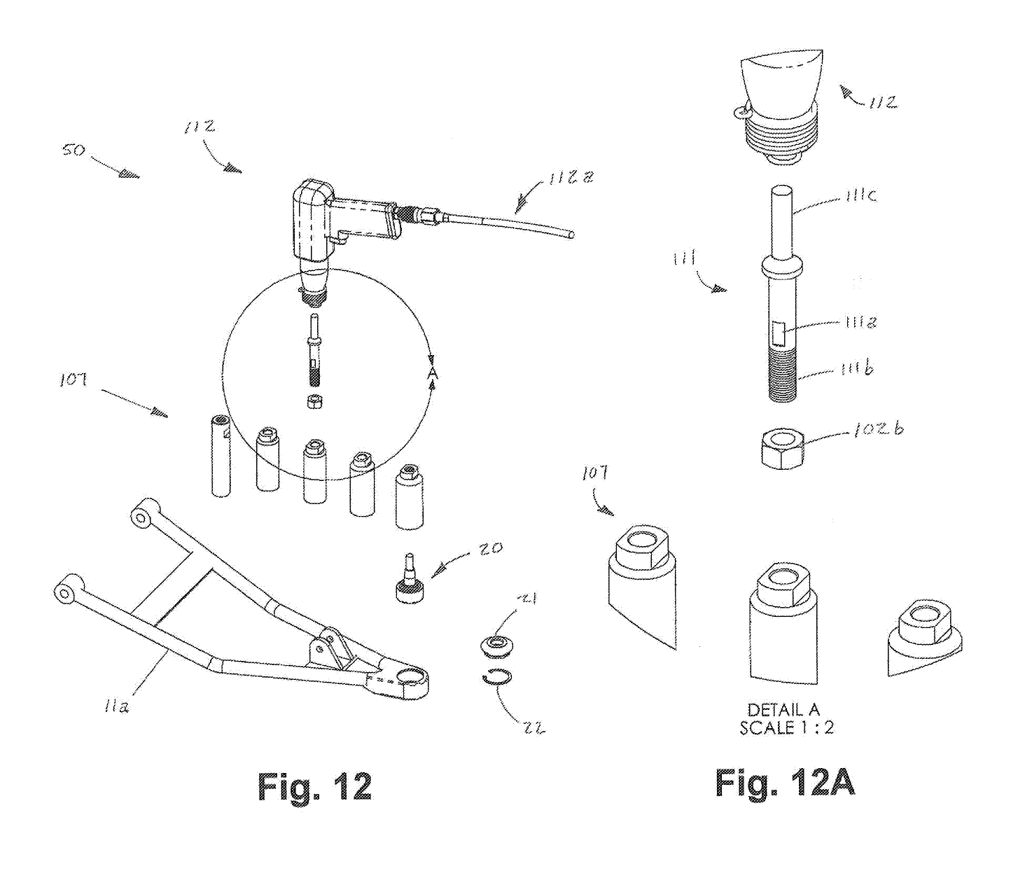

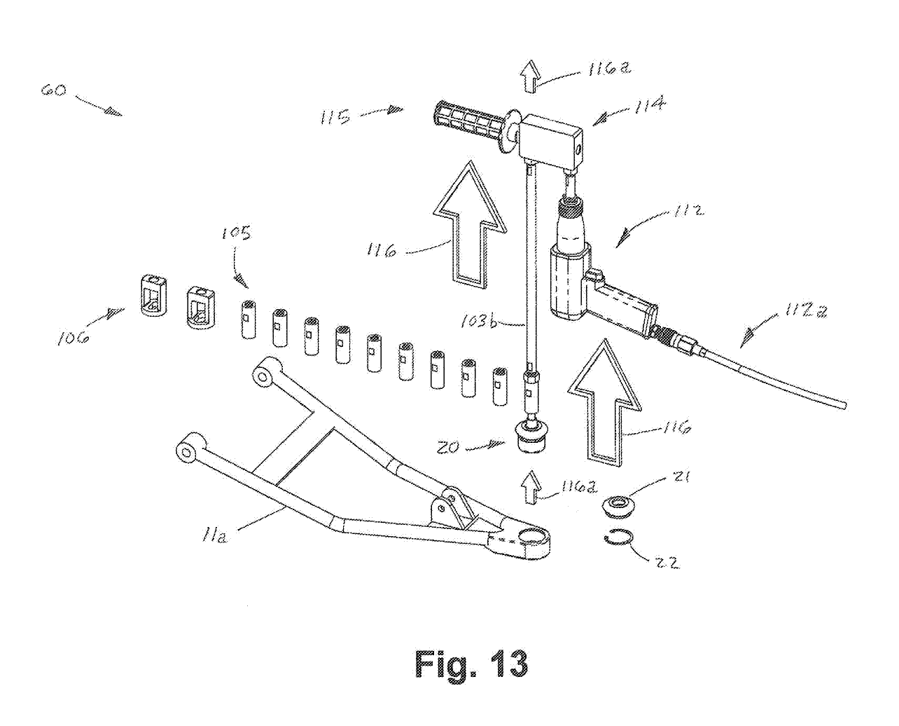

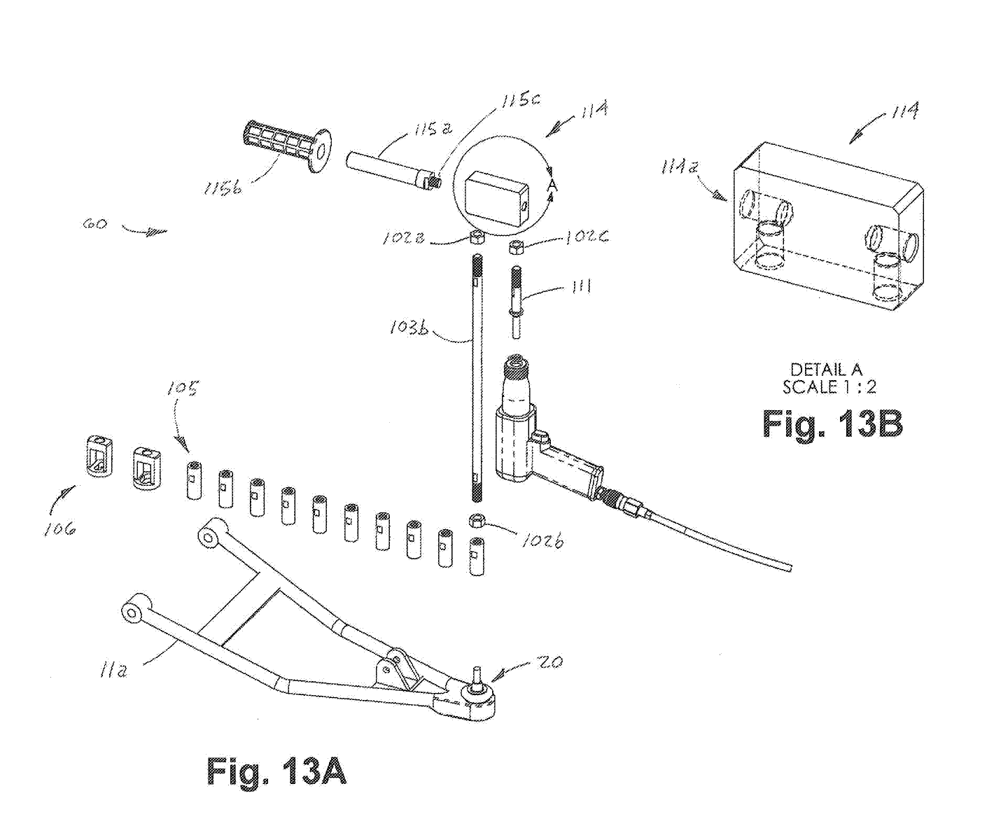

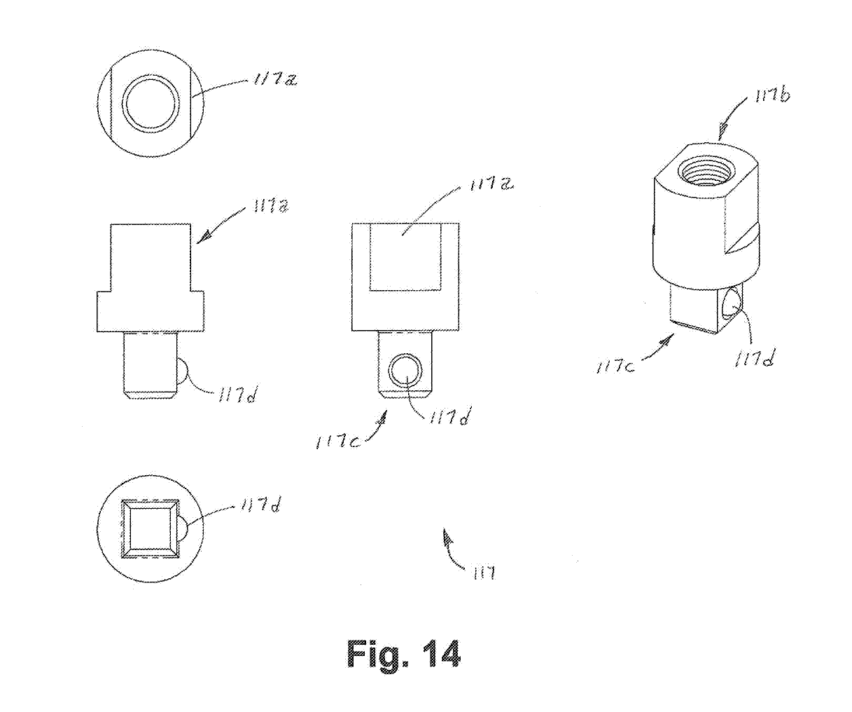

FIG. 1OF is a front view of the in-use apparatus shown in FIG. 10E;

FIG. 10G is a detailed cross-section view of one end of the in-use apparatus of FIG. 10F;

FIG. 11 is a detailed view of another example embodiment, showing a portion of tools and suspension components related to the three-quarter example perspective view of FIG. 1;

FIG. 11A are detailed views of an example two-piece ball joint install driver shown in FIG. 11;

FIG. 11B are detailed views of an example two-piece ball joint install driver shown in FIG. 11;

FIG. 12 is a detailed view of another example embodiment, showing a portion of tools and suspension components related to the present invention;

FIG. 12A is a detailed view of the three-quarter example perspective view of FIG. 12;

FIG. 13 is a detailed view of the in-use apparatus shown in FIG. 12;

FIG. 13A is an exploded view of the apparatus shown in FIG. 13;

FIG. 13B is a detailed view of a pneumatic impact hammer adapter block shown in FIG. 13A; and

FIG. 14 are views of a square drive socket threaded adapter tool related to the present invention.

### DESCRIPTION OF THE PREFERRED EMBODIMENTS

Referring now to the drawings and the illustrative embodiments depicted therein, FIG. 1 generally illustrates an example front suspension assembly 2 as may typically be utilized on most commercially available 4-wheeled off-road all-terrain vehicles (ATV), off-road side-by-side recreation or utility vehicles, as well as snowmobiles. While the related supporting structural suspension members shown are for a wheeled vehicle, the suspension may, for example, instead be re-illustrated and configured to show support of a pair of snowmobile skis in place of the wheels and tires.

In a first example embodiment, the ATV, side-by-side, and snowmobile universal ball joint remover and installer service kit and tools 1 is generally represented by and comprised of an impact slide hammer assembly 1A, a kit or series of dual-thread ball joint remover adapters 105, and a kit or pair of universal ball joint adapters 106.

FIG. 1 further illustrates a typical tire and wheel assembly 3, normally held and secured by threaded wheel nut fasteners 4 at threaded wheel studs 5 at wheel hub 6. Brake disk 7 is rotatably supported by steering knuckle 8 and further may optionally include brake caliper 9. Lower ball joint 10 is typically attached to lower control arm 11 by means of an interference press-fit. A retaining ring (not shown) is often used to further secure the lower ball joint 10 (not shown in FIG. 1). Likewise, upper ball joint 12 is similarly attached and secured to upper control arm 13. Shock absorber 14 and spring 15 support and suspend the main frame 16 of the machine. Main frame upper and lower control arm pivot axes and attachment points at 16a and 16b, respectively, allow free rotational movement of the control arms 11 and 13 about their respective axes of rotation. The respective upper and lower ball joints 10 and 12 provide a limited spherical freedom of movement and central pivoting about their respective single points of free rotation at and between the respective control arms 11 and 13 and the steering knuckle 8. This allows for both for free vertical rotational movement of the respective suspension control arms 11 and 13 when traveling over bumps, while further providing both left and right turning and steering of the steering knuckle 8 and the tire and wheel assemblies 3 (in FIG. 1 the respective left and right steering tie-rods and steering arms at the steering knuckles 8 are not shown for the sake of clarity).

Therefore, it is essential that both the upper and lower ball joints 12 and 10 remain tight yet freely movable and rotatable. However, excessive play or freedom of movement due to excessive wear or damage is likely to occur through extended use or continued heavy suspension impacts of the vehicle over rough terrain. If one or all of the ball joints become worn or otherwise damaged resulting in excessive looseness or free play, they must be replaced. Likewise, if a ball joint becomes excessively tight due to lack of proper grease lubrication or corrosion it too must be replaced. It is an aspect of the present invention to provide an improved set of tools and adapters, for example shown as items 1a, 105, and 106, in the form of a universal kit 1 or otherwise a series of various kits, which anticipates the most common various suspension designs and ball joint installations for ATV's, snowmobiles and utility vehicles. The kit of the present invention greatly facilitates the current service and repair process generally regardless of the variations in the designs of the vehicle suspension systems and in particular the ball joints themselves, as discussed in detail below.

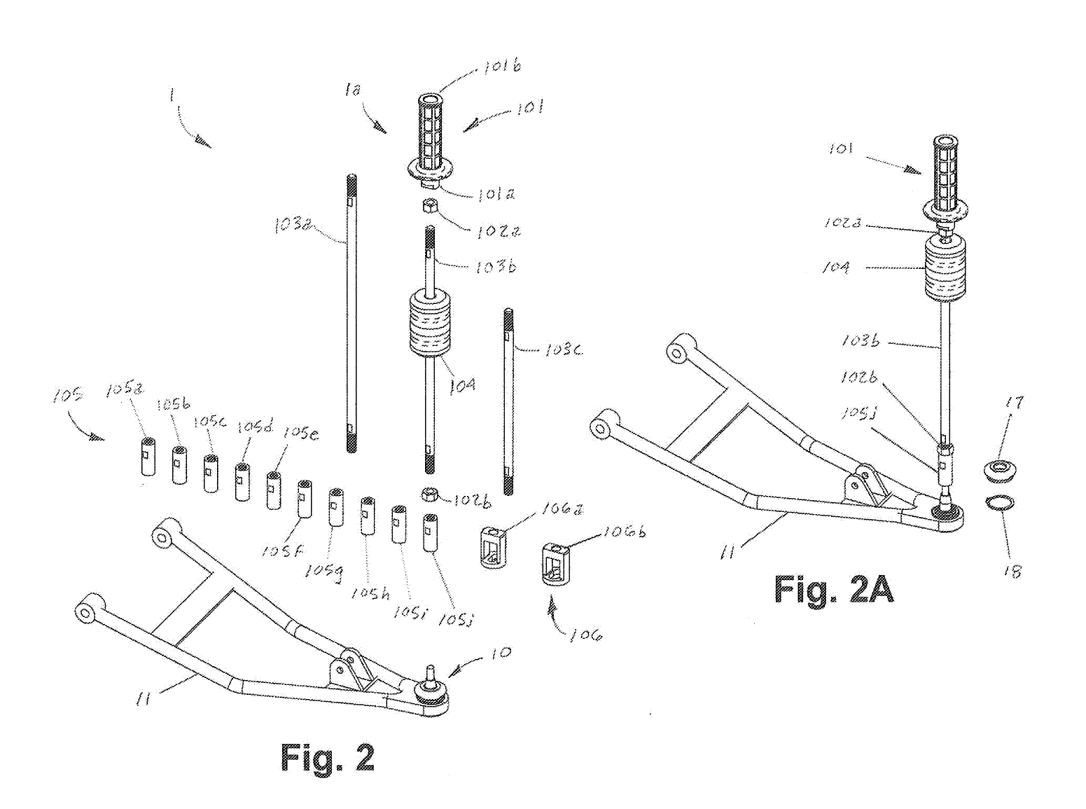

FIG. 2 illustrates an example first embodiment of the present invention as a tool kit 1. Generally, an impact slide hammer assembly 1A is comprised of slide hammer handle assembly 101 further including handle support member 101a and handle grip 101b. A selection of three different lengths of slide hammer rods, 103a, 103b, and 103c are included within the kit to facilitate selection and the desired amount of impact energy of the slide hammer 1a and the particular access space available during the use of the slide hammer 1a.

The selected slide hammer rod (103b in this instance) is threadably engaged with handle assembly 101 and secured by threaded hex nut 102a. Slide hammer weight 104 is then slidably engaged onto slide hammer rod 103b. Next, one of the dual-thread ball joint remover adapters (105a through 105j) is selected according the specific different thread sizes provided at the bottom portion of each of the adapters (105a through 105j). The desired thread size is selected to match and threadably engage the ball joint stud thread 10b at the top of the lower ball joint 10. The number of adapters in a kit may vary depending upon the range of unique thread diameters and thread pitches desired to accommodate the various and most common metric and SAE ball joint stud threads.

The selected thread size, which allows for the selected interchange of the various tool components and adapters, may be a common size and pitch of thread, for example ½-20 UNF thread classes 2A and/or 2B, or optionally increased looseness classes 3A and/or 3B, which allows for the free and rapid assembly, tightening, and free and rapid disassembly of the tool components as they are quickly installed and removed during the repair processes.

The dual-thread ball joint adapters (105a through 105j) for example all have at one end a common thread size (½-20 thread for example). This common thread provides interchangeability of the adapters with the various length slide hammer rods 103a, 103b, and 103c. The opposite end of each these adapters 105a through 105j have a different and unique thread selected to match what are expected to be the most common sizes of threads that are typically found to be used with ATV and snowmobile ball joints. For example, a selection of adapter thread sizes 105a through 105j may include the following common metric and SAE threads, such as, for example, 10 mm×1.25, 10 mm×1.50, 12 mm×1.25, 12 mm×1.50, 13 mm×1.25, 13 mm×1.50, ⅜-20, ⅜-24, ½-20, 7/16-20. Any number of additional and optional thread sizes are also possible based upon common current and changing standards in the ATV and snowmobile market industries for example.

It may be noted that each of the tools and adapters related to this invention may be comprised of high quality steel such as for example grade 4340 or other preferred grades of machinable and/or heat treatable materials selected based on both strength and durability through repeated use and stress. Some tool components, such as the slide hammer 104 for example, may be comprised of mild steel or cast grades of steel.

As shown in FIG. 2A, ball joint rubber boot 17 and ball joint external retaining snap ring 18 have been removed from lower ball joint 10 to facilitate its removal from the lower control arm 11a. The ball joint remover adapter (in this example instance 105j) is then threadably engaged with slide hammer rod 103b and further secured by tightening threaded hex nut 102b.

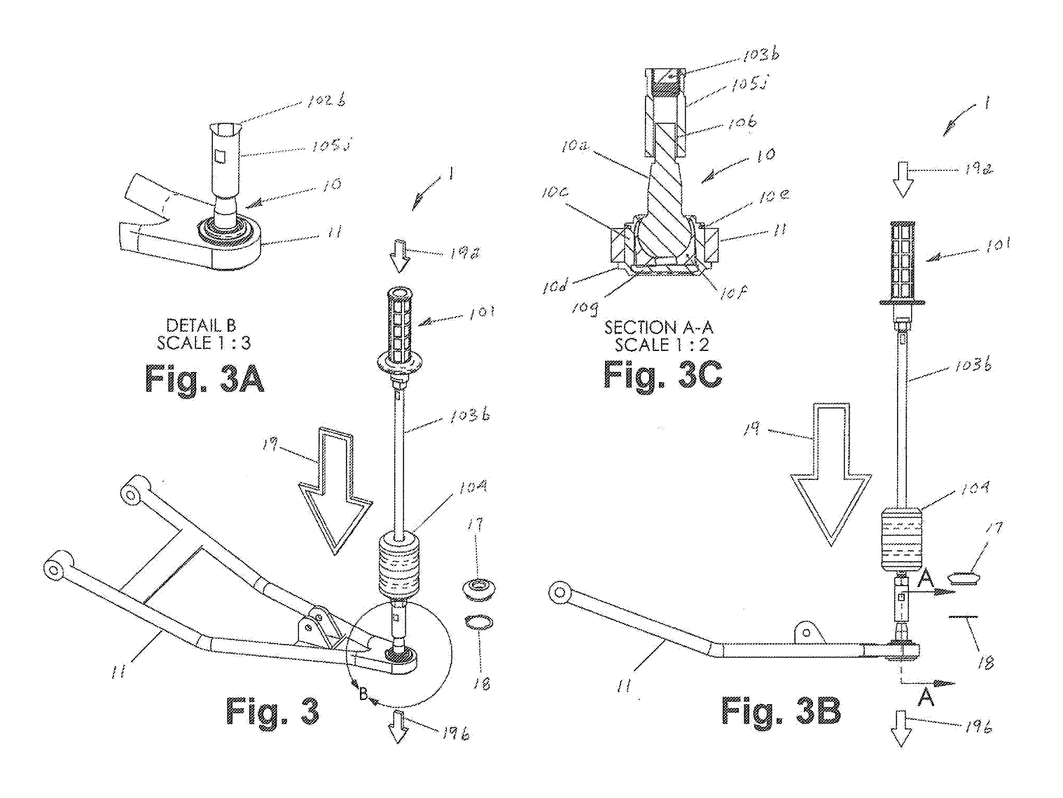

FIG. 3 illustrates the application of the slide hammer assembly 101 to engage and remove the lower ball joint 10 from the lower control arm 11 since the ball joint is held firmly in place by design by means of a friction interference or press-fit. Grasping the handle assembly 101 with one hand (not shown for clarity) and rapidly sliding the hammer weight 104 downward with the other hand (not shown for clarity) results in producing a slide hammer impact force direction 19 applied at downward direction along the vertical axis of the slide hammer further represented by impact force direction arrows 19a and 19b. A series of repeated blows will gradually force and advance the lower ball joint downward and outward, thus disengaging it from of the lower control arm 11 after a series of impact blows. Whether the lower control arm 11 remains attached to the machine at the frame 16 (as shown in FIG. 1) or whether the arm has been completely removed from the vehicle, some type of support under the arm in the form of a jack stand and/or wooden blocks (not shown) may be desirable or necessary to support the control arm 11 to effectively oppose the reaction to the impact forces applied by the slide hammer 1a and its sliding weight 104.

FIG. 3A shows a detail view of FIG. 3, while FIG. 3B shows a front view of the arrangement shown in FIG. 3. FIG. 3C illustrates an example of one generally common style of a ball joint assembly in cross-section. In this case, both the ball joint rubber boot 17 and external retaining snap ring 18 have been removed.

Some particular detail features for a typical ball joint assembly 10 further include ball joint stud 10a, stud thread 10b, outer race 10c, outer race shoulder 10d, snap ring groove 10e, bearing material 10f, and cap 10g. The ball joint hex nut (not shown) used to secure the stud within its location in the steering knuckle 8 has been removed to allow threaded engagement of the remover adapter 105j in this example. It should be noted that this style of ball joint 10 is both removed and installed from the underside of the control arm 11 due to the outer race shoulder 10d acting as a location stop at the control arm 11a when correctly installed. Other basic orientations of the ball joint 10 including the control arm 11, and the application the slide hammer 1a are anticipated while remaining within the spirit and scope of the present invention.

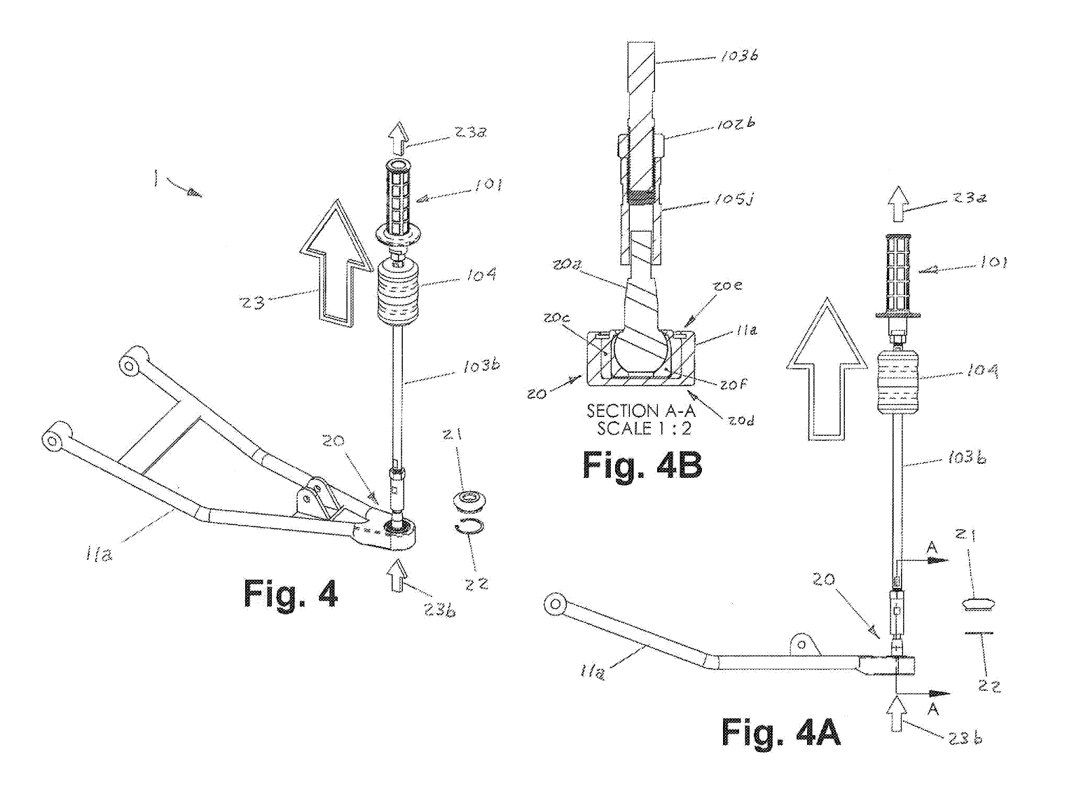

Referring to FIGS. 4, 4A, and 4B, this second use or method example of the kit embodiment 1 of the present invention includes several similarities to the example previously shown, however in this case the direction of impact force has been reversed. A fully detailed description will be understood to be unnecessary, focusing instead on the differences. In this second use or method example, the lower ball joint 20 and the lower control arm 11a is of a different design. FIG. 4B illustrates another example of one common style of a ball joint assembly in cross-section. In this case, both the ball joint rubber boot 21 and internal retaining snap ring 22 (rather than an external retaining snap ring) have been removed. The example detail features for ball joint assembly 20 further include ball joint stud 20a, stud thread 20b, outer race 20c, snap ring groove 20e (which in this case, is instead located within the control arm 11a), and bearing material 20f. It should be noted that this style of ball joint design represents a “blind installation” where the “cap end” (cap 10g) becomes the equivalent of the “shouldered stop” of the previous example within the control arm 11a itself once correctly installed. Because of this “blind design” the ball joint assembly 20 can only be accessed for removal and installed from one side (in this instance the upper side) of the control arm 11a. Therefore, since the ball joint is held firmly in place by design by means of a friction interference or press-fit, and with no access to the blind end of the ball joint assembly 20 when in place within the control arm 11a, an upward pulling force 23, 23a and 23b will be necessary to extract the ball joint assembly from the control arm 11a. Once again in this example, the ball joint hex nut 20h used to secure the stud within its location in the steering knuckle 8 has been removed to allow threaded engagement of the remover adapter 105j. Other basic orientations of the ball joint 20, including the control arm 11a and the application of slide hammer 1a are anticipated without affecting the scope of the present invention.

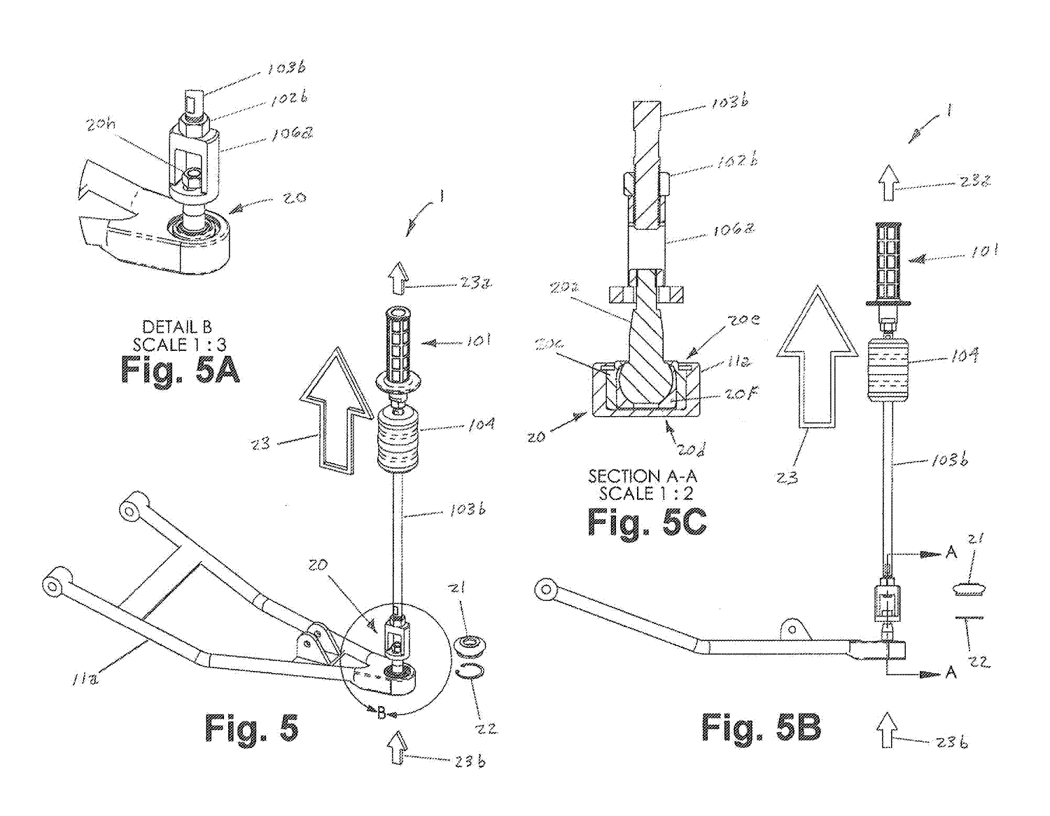

Referring to FIGS. 5, 5A, 5B and 5C, this third use or method example of kit embodiment 1 of the present invention includes several similarities to the examples previously shown. A fully detailed description will be understood to be unnecessary, focusing instead on the differences. A difference shown in this third example embodiment of the present invention is that a universal ball joint small adapter 106a is being utilized to pull or otherwise extract the ball joint assembly 20 from the control arm 11a. The advantage of both the small and large universal ball joint adapters 106a and 106b, respectively, is that these can be used to attach to and extract any “blind style” ball joint assembly, provided that the matching thread ball joint hex nut 20h is available to attach the universal adapter to the ball joint threaded stud. The advantage in this potential instance is that if a particularly unusual ball joint thread is encountered that does not match any of the dual-thread ball joint remover adapters 105a through 105j for example, these universal adapters 106a and 106b can offer a quick and workable solution.

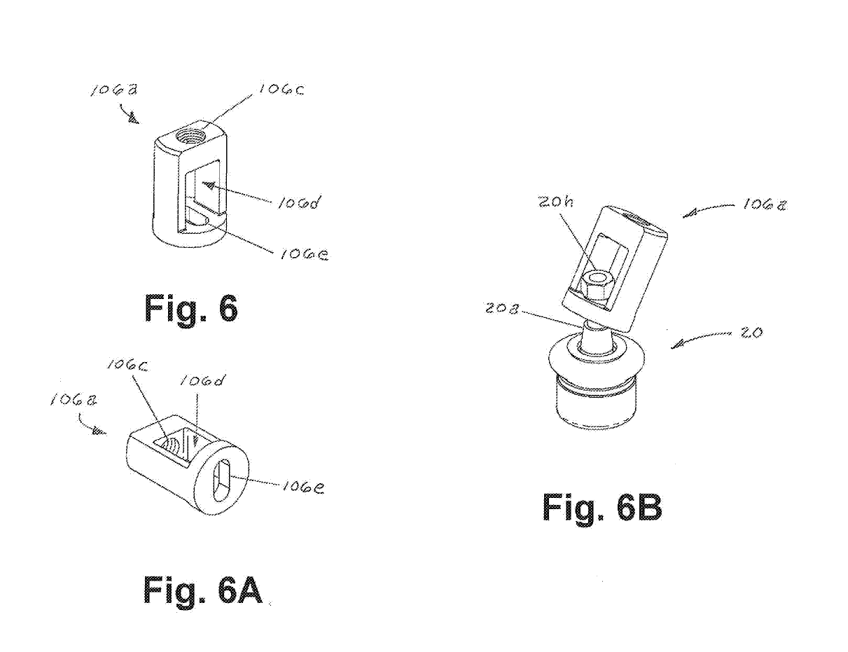

FIG. 6 shows universal ball joint small adapter 106a as an example in detail including the adapter threaded end 106c which matches the thread provided for attachment at the ends of the slide hammer rods 103a, 103b and 103c, an aperture window 106d providing clearance for a ball stud hex nut 20h, and a slotted end 106e. As shown in FIG. 6A, slotted end 106e allows the universal adapter 106a to be tipped (as much as 45 degrees (for example) with respect to the ball joint stud 20a during installation and ease-of-access for both tightening and loosening of the ball stud hex nut 20 at ball joint stud 20a.

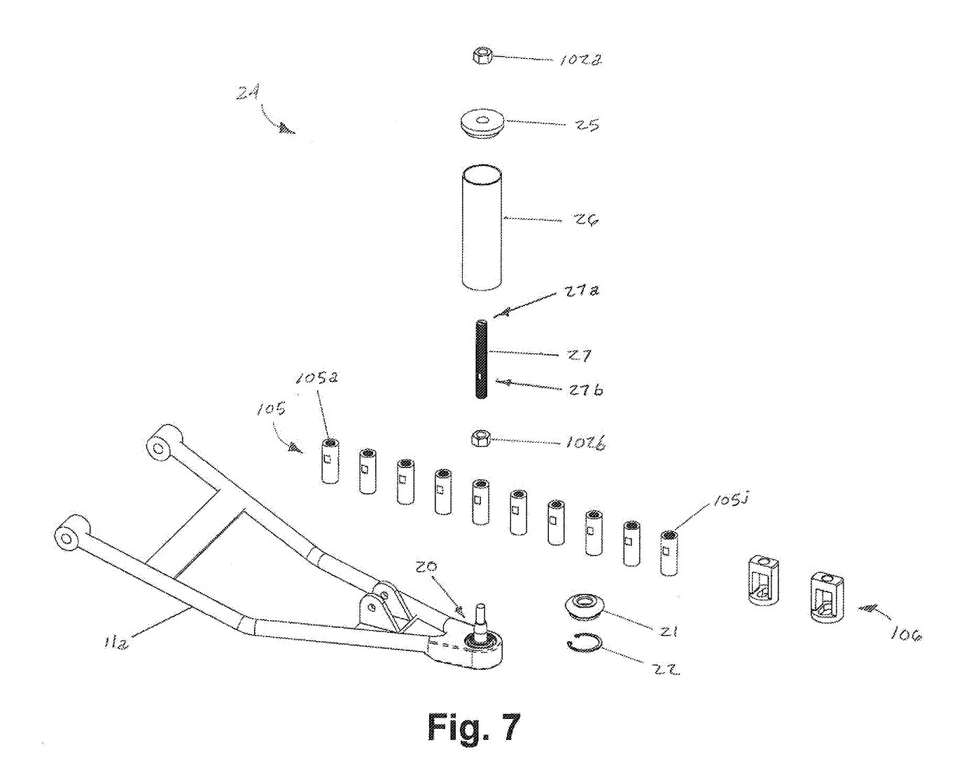

Referring to FIG. 7, this second example kit embodiment 24 of the present invention is generally comprised of a cylindrical (or sleeve) puller kit assembly 24 and includes several similarities to the earlier embodiments previously shown. A fully detailed description will be understood to be unnecessary, focusing instead on the differences. A difference shown in this fourth example embodiment of the present invention is that a thin-wall cylindrical tube or sleeve is provided as an option for the removal and extraction of “blind style” ball joint assemblies. Optionally, and in selected instances, this can be used in place of the impact slide hammer assembly 1a as shown in the previous example embodiments and methods of use.

Cylindrical puller kit assembly 24 is comprised of a puller cap 25, sleeve tube 26, threaded rod 27, and hex nuts 102a and 102b. Threaded rod 27 further includes a slotted end 27a for engagement with a flat-bladed screw driver as desired, and wrench flats 27b. Also, included for the sake of example is the dual-thread ball joint adapter kit 105, further including the series of adapters 105a through 105j. Further shown are the universal adapters 106a and 106b. Other basic orientations of the ball joint 20, including the control arm 11a and the application of cylindrical puller assembly 24 are anticipated without affecting the scope of the present invention.

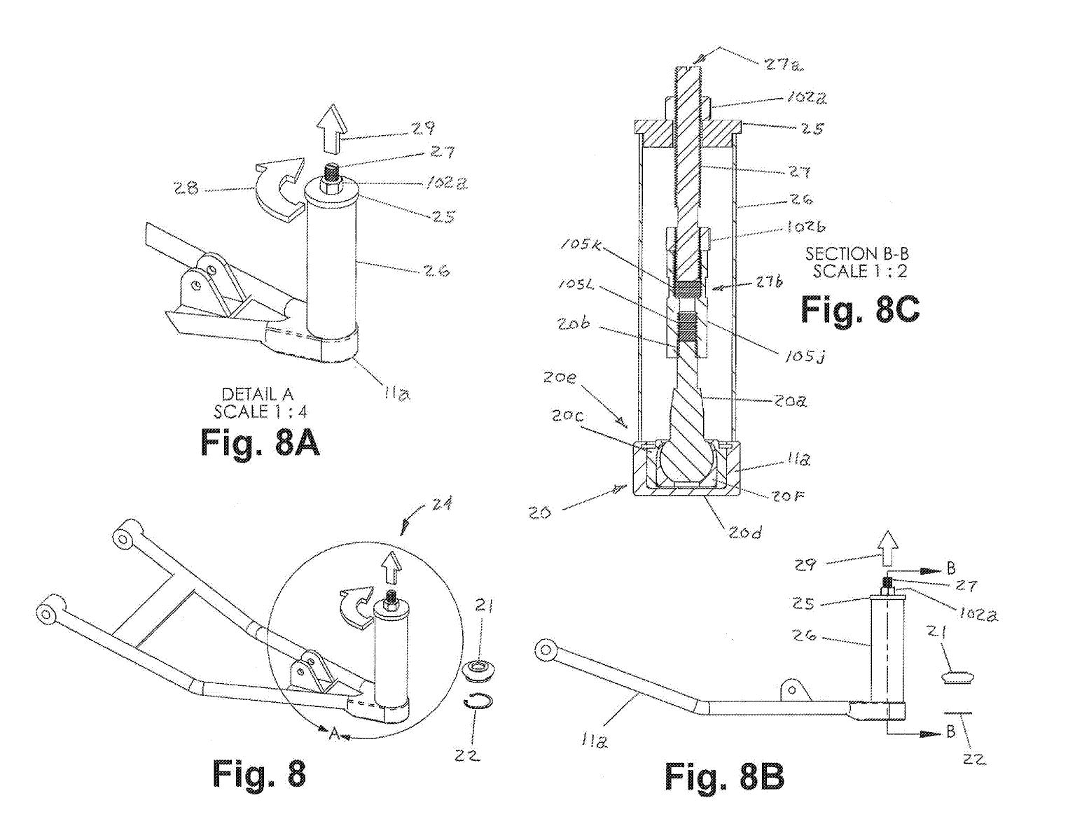

FIGS. 8, 8A, 8B, and 8C show a typical arrangement and use of the cylindrical puller assembly kit assembly 24 when in use. Turning threaded hex nut 102a clockwise as shown by direction of rotation arrow 28, applies an upward force to extract the ball joint assembly 20 from the control arm 11a. Slotted end 27a may be used to prevent rotation of threaded rod 27 during the tightening process by use of a flat-blade screw driver or the like (not shown).

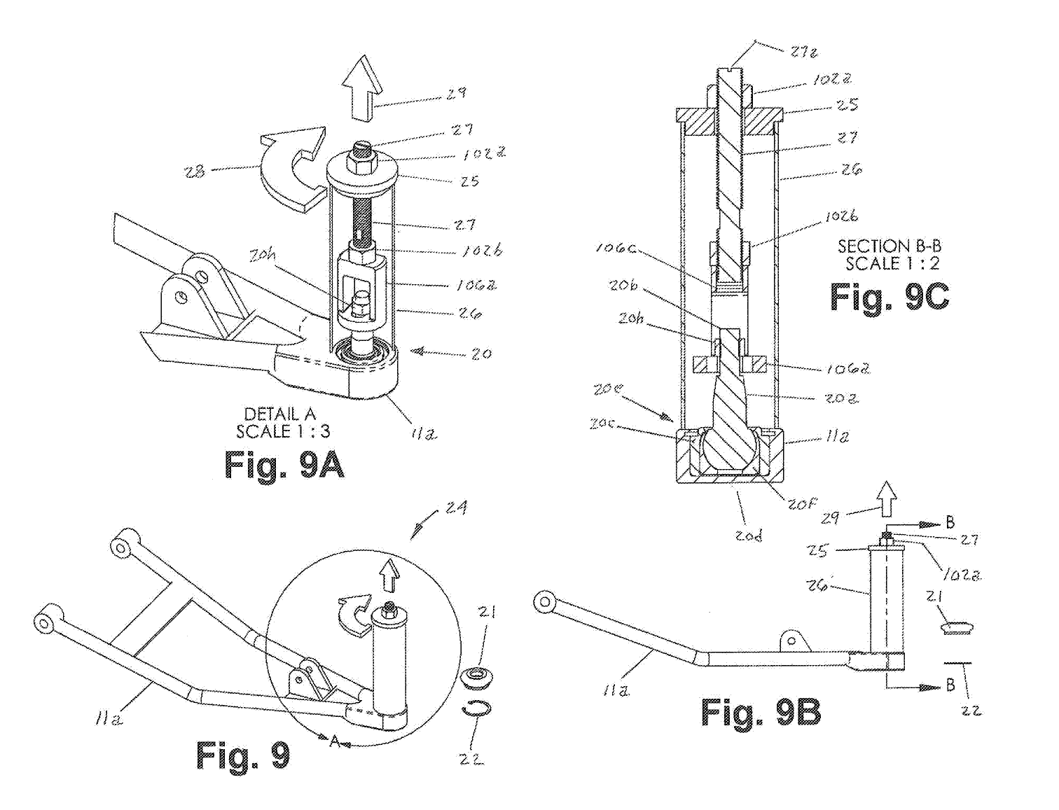

Referring to FIGS. 9, 9A, 9B, and 9C, a second use or method of the cylindrical puller kit assembly 24 of the present invention includes many similarities to the earlier embodiments previously shown. A fully detailed description will be understood to be unnecessary, focusing instead on the differences. A difference shown in this use example of the present invention is that a specially designed universal ball joint small adapter 106a is provided as an option in place of one of the series of adapters 105a through 105j for the removal and extraction of an example “blind style” ball joint assembly 20 from lower control arm 11a. Other basic orientations of the ball joint 20, including the control arm 11a and the application of cylindrical puller assembly 24 are anticipated without affecting the scope of the present invention.

Referring to FIGS. 10, 10A, 10B, 10C, 10D, 10E, 10F, and 10G, this third example embodiment as ball joint impact driving kit 30, shows an example of forcibly driving and re-installing a new “shouldered” ball joint assembly into a control arm 11a, or otherwise into a control arm 11a having a “blind” installation. As shown in FIG. 10, impact slide hammer assembly 1a is again utilized as before, however in this use and method a series of one-piece ball joint install drivers 107 may be utilized. One of the install drivers of the kit 30 is selected based upon its diameter to most closely match the ball joint at ball joint outer race 20c as best shown in FIG. 10G. In this case, at least one of the install drivers 107 is selected and used to-install or drive a new ball joint assembly 20 into place by means of a “press-fit” or “interference fit” into its desired position with respect to control arm 11a. The advantage of this is that this task is accomplished without the need for a hydraulic or heavy-duty mechanical-screw shop press, or the like for example, to complete the ball joint installation. A series of one-piece ball joint install drivers as a kit 107 includes drivers of various diameters for use with different sizes or diameter ball joint assemblies 20 that may be most commonly anticipated.

FIG. 10A illustrates by example the smallest diameter one-piece driver 107a of the present kit example 30. One-piece driver 107a includes wrench flats 107f to allow tightening of the driver onto a selected slide hammer rod 103a, 103b, or 103c at internal thread 107g. Internal diameter 107h is sized and provided to properly engage outer race 20c of ball joint assembly 20 of a given size diameter as best shown by FIG. 10G cross-sectional example view. The depth of internal diameter 107h in each case is generally deep enough to provide sufficient clearance for the ball joint stud 20a during the installation procedure.

FIG. 10B represents an example of the present largest diameter one-piece driver 107e of the present kit example 30. Likewise, one-piece driver 107e also includes wrench flats 107f, driver rod thread 107g, and internal diameter 107h. Internal diameter 107h is provided to engage outer race 20c of ball joint assembly 20 of a given larger diameter size as best shown by FIG. 10G cross-sectional example view. Again, the depth of internal diameter 107h in each case is generally deep enough to provide sufficient clearance for the ball joint stud 20a.

FIGS. 10C and 10D illustrate the initial arrangement and alignment of the impact slide hammer assembly 1a, one-piece driver 107c, ball joint assembly 20 and control arm 11a.

FIGS. 10E, 10F, and 10G, illustrate by example the process of driving a new ball joint assembly 20 into control arm 11a. A series of multiple and repeated striking blows of the slide hammer weight 104 shown by force direction arrows 19, 19a, and 19b gradually drives the new ball joint assembly into its correct position within the control arm 11a. Once the new ball joint assembly is in place, the internal retaining snap ring 22 and a new ball joint rubber boot 21 are re-installed including lubricating grease to complete the installation. Grease lubrication may be applied directly to the ball joint during the installation procedure or by means of a grease fitting using a pressurized grease gun after the assembly process if the particular ball joint is provided with a lubrication fitting.

Referring to FIG. 11, this fourth example embodiment of a ball joint impact driving kit 40 is very similar in function to the previous impact driving kit 30. Once again, one of the install drivers of the kit 30 is selected based upon its diameter to most closely match the ball joint at ball joint outer race 20c as best shown in FIG. 10G. As shown in FIG. 11, impact slide hammer assembly 1a is again utilized as in the previous example. In this kit embodiment 40 however, a series of two-piece piece ball joint install drivers 108 represents a design and manufacturing improvement and advantage over the one-piece ball joint install drivers 107 shown in the previous example. As previously described, install drivers kit 108 includes range of drivers of various diameters that may be anticipated for use with different sizes or diameter ball joint assemblies 20 that may be encountered. FIG. 11 illustrates by example up to nine two-piece drivers in selected incremental step sizes from the smallest anticipated diameter to the largest anticipated diameter of most common ball joints.

Referring to FIG. 11A, an example two-piece driver 108g includes an individually machined install driver cap 109g which is separate from the corresponding diameter install driver sleeve 110g. This inherent difference represents a significant reduction in machining time, effort and cost compared to the single-piece series of drivers 107 (107a through 107e) previously described. The one-piece series of drivers 107a-e must typically be machined from solid round bar stock. In this case, the internal diameter represents a significant amount of material to be removed and discarded as waste material during the machining process at a considerable increase in time and cost compared to the present two-piece design.

As ATV, side-by-side, and snowmobile universal ball joint remover and installer service kits and tools are manufactured in quantity for sales and distribution to customers, this represents a significant overall product cost savings. This particular product manufacturing cost reduction quickly and readily becomes a significant competitive advantage within potentially competitive tool markets.

DETAIL C of FIG. 11A illustrates a first optional method of design and manufacture the two-piece example driver 108g. The first method is accomplished by an interference press-fit between the surfaces at the inside diameter of sleeve 110g and the outer diameter surface of surfaces 108p of driver cap 109a. In this embodiment, the press-fit design represents a relatively quick and inexpensive means of manufacturing to secure the cap 109g to the driver sleeve 110g. This method of manufacture can be applied to the complete series of drivers 108 shown in FIG. 11. This represents a further cost advantage as compared to a second optional design and method of manufacture which may include a series of spot welds, or a continuous seam-welded joint shown by circumferential weld cross-section 108w by DETAIL C of FIG. 11A.

DETAIL D of FIG. 11A additionally shows a third design and manufacturing option including a fine-machined outer diameter 108m and/or a fine machined inner diameter 108n. These fine-machined “step diameters” further offer the option or capability to readily customize or otherwise respond to various common diameters of ball joints and newly emerging changes to ball joint design within the ATV vehicles and snowmobile industries and markets. This design feature offers considerable flexibility as may be necessary to satisfy customer demand for correctly sized driver adapters in a rapidly changing market.

Referring to FIG. 11B, a fourth optional design and method of manufacture of the series of the two-piece example drivers 108 is illustrated by DETAIL E. In this example, an O-ring groove has been added to driver cap 109g whereby a rubber O-ring may be installed to provide a hand-tight friction fit between the free-fitting inner surface diameter of install driver sleeve 110g and driver cap 109g. This potential method of design and manufacturing offers the possibility of multiple and readily changeable driver sleeves 110g which may utilize the same driver cap or a few common sized driver caps. This offers increased flexibly of the tool kit through selectively interchangeable multiples of both internal and external fine-machined diameters within a set of ball joint driver adapters.

Additionally, the hand-removable sleeves shown in FIG. 11B offer the ability to be readily separable from their corresponding driver caps. This design feature offers the increased potential for nesting the various diameters of driver sleeves within a given tool kit thus providing the opportunity and advantages of reducing the overall physical size of a given tool kit, and further providing improved efficiently of product packaging.

Referring to FIGS. 12 and 12A, a fifth example of a kit embodiment 50 of the present invention is very similar the third kit embodiment 30 of the present invention, however in this case an optional pneumatic impact hammer 112 takes the place of the impact slide hammer assembly 1a. This fifth example embodiment provides for a method of powered installation of an example ball joint assembly 20 into a lower control arm 11a. This example kit includes and utilizes an impact hammer threaded adapter 111. The impact hammer threaded adapter 111 further includes wrench flats 111a, adapter threads 111b for ready attachment with a variety of other tools and adapter components within the kit, and an adapter shank 111c for operable engagement with generally common and commercially available pneumatic impact hammers 112. A supply of pressurized air is provided from a remote source, such as an air compressor for example (not shown) through an air supply hose 112a.

Referring to FIG. 13, a sixth example of a kit embodiment 60 of the present invention is comparable that of the earlier example embodiments of the present invention shown in FIGS. 2 and 2A, and further including the third example embodiment of FIGS. 5, 5A, 5B, and 5C. A fully detailed description will be understood to be unnecessary, focusing instead on the differences. This sixth example embodiment 60 provides for a method of powered removal of an example ball joint assembly 20 from a lower control arm 11a. Again, a supply of pressurized air is provided from a remote source, such as an air compressor for example (not shown) through an air supply hose 112a.

Operation of the pneumatic impact hammer 112 while threadably engaged with impact hammer adapter block 114 provides an impact force direction 116 and 116a through slide hammer rod 103b (for example) at lower ball joint assembly 20. Multiple and rapidly repeated blows of the pneumatic impact hammer 112 along with an upward and supporting lift by hand (not shown) at adapter block support handle assembly 115 provides for rapid-pulsed powered impact removal of the ball joint assembly 20.

FIG. 13A provides an exploded view of the kit embodiment 60 components shown in FIG. 13.

FIG. 13B shows a detailed view of the pneumatic impact hammer adapter block 114 including at least four threaded points of engagement and attachment of the various kit components previously shown in FIGS. 13 and 13A.

FIG. 14 shows orthographic views and a perspective view of another adapter example embodiment 117 of the present invention in the form of a square drive socket threaded adapter 117. This adapter tool includes wrench flats 117a, adapter threads 117b for threaded engagement for example, with slide hammer impact rods 103a, 103b, 103c and pneumatic impact hammer threaded adapter 111. An adapter 117 further includes a spring-pre-loaded detent ball is provided at ½ inch square (for example) drive portion 117a for securing any commonly available standard tool-½-inch drive (for example) tool or wrench sockets. In this case, commonly available ½ inch drive sockets may be optionally utilized as a ball joint driver, thus providing the user with an optionally suitable driver adapter of a selected diameter during unanticipated or unusual circumstances.

Changes and modifications in the specifically described embodiments can be carried out without departing from the principles of the present invention which is intended to be limited only by the scope of the appended claims, as interpreted according to the principles of patent law including the doctrine of equivalents.

1. An all-terrain vehicle (ATV), side-by-side off-road vehicle or snowmobile universal ball joint installation and removal tool kit for the purpose of service and repair or removal and installation of ball joint suspension components, said kit comprising:
at least one slide hammer tool assembly comprising a slide hammer rod member, a slidable weight movably disposed at the slide hammer rod member and a handle;
wherein the slide hammer rod member comprises a first end and a second end, and wherein the handle is attachable at the first end of the slide hammer rod member;
a plurality of adapter members for mechanical attachment or engagement with respective ones of different sized ball joint suspension components;
wherein each of the adapter members is configured to attach at the second end of the slide hammer rod member; and
wherein, when servicing ball joint suspension components, a selected adapter member is mechanically attached to a particular ball joint suspension component and attached at the second end of the slide hammer rod member, whereby movement of the slidable weight along the slide hammer rod member functions to install or remove the ball joint suspension component.

2. The kit of claim 1, comprising a plurality of slide hammer rod members, wherein said slide hammer rod members have different lengths.

3. The kit of claim 1, wherein the first and second ends comprise threaded end portions of the slide hammer rod member.

4. The kit of claim 1, wherein the handle includes a threaded end portion for threaded engagement with the first end of the slide hammer rod member.

5. The kit of claim 1, wherein each of the plurality of adaptor members includes a first end and a second end, and wherein the first end of the adaptor member comprises a threaded portion for mechanical attachment to the second end of the slide hammer rod member, and wherein the second end of the adaptor member comprises a threaded portion for mechanical attachment to the ball joint suspension component.

6. The kit of claim 5, wherein the threaded portions of the second ends of the plurality of adapters comprise different thread diameters and/or thread pitches corresponding to respective ones of different thread diameters and thread pitches for various all-terrain vehicle (ATV), side-by-side off-road vehicle or snowmobile universal ball joint suspension components.

7. The kit of claim 1, wherein each of the plurality of adaptor members includes a body portion having a first end and a second end, and wherein the first end of the adaptor member comprises a threaded portion for mechanical attachment to the second end of the slide hammer rod member, and wherein a central portion of the body portion of the adaptor member includes a first aperture extending through the body portion of the adapter member comprising a clearance opening, and wherein the second end includes a second aperture for mechanical attachment to the ball joint suspension component.

8. The kit of claim 7, wherein the first aperture extends generally only part-way into the body portion of the adapter member comprising a clearance opening.

9. The kit of claim 7, wherein the second end aperture for mechanical attachment to the ball joint suspension component comprises a slotted through-opening.

10. The kit of claim 7, wherein the second end aperture for mechanical attachment to the ball joint suspension component comprises a circular through-opening.

11. The kit of claim 1, wherein at least some of the adapter members comprises a driver having a first end and a second end, and wherein the first end of the driver comprises a threaded portion for mechanical attachment to the second end of the slide hammer rod member, and wherein the second end of the driver comprises a cylindrical tube or sleeve configured for mechanical impact engagement with the ball joint suspension component.

12. The kit of claim 11, wherein the driver comprises a unitary cylindrical member.

13. The kit of claim 11, wherein the driver comprises a two-piece adapter member having a cap member and a cylindrical tube or sleeve member.

14. The kit of claim 13, wherein the cap member is configured to loosely engage the cylindrical tube or sleeve member at a piloted circular step portion of the cap and end portion of the cylindrical tube of sleeve member.

15. The kit of claim 13, wherein the cap member is configured for permanent press-fit engagement of the cylindrical tube or sleeve member at a piloted circular step portion of the cap and end portion of the cylindrical tube of sleeve member.

16. The kit of claim 13, wherein the cap member is configured for welded engagement of the cylindrical tube or sleeve member at a piloted circular step portion of the cap and end portion of the cylindrical tube of sleeve member.

17. The kit of claim 13, wherein, for mechanical attachment or engagement of a ball joint suspension component to the slide hammer tool assembly, the cylindrical end or sleeve portion of the adapter is readily adaptable to various size said suspension ball joint assemblies by a fine-machining process.

18. An all-terrain vehicle (ATV), side-by-side off-road vehicle or snowmobile universal ball joint installation and removal tool kit for the purpose of service and repair or removal and installation of ball joint suspension components, said kit comprising:
at least one cylindrical puller assembly comprising a cylindrical puller tube member, a cylindrical puller cap member, a threaded rod member, a plurality of threaded fasteners, and a plurality of adapter members;
wherein the adapter members comprise different sized receiving holes for receiving different sized ball joint suspension components, and wherein each adapter member is configured for mechanical attachment or engagement with a respective ball joint suspension component and is configured for mechanical attachment to the threaded rod member; and
wherein the puller tube member, when a selected adapter member is attached at a respective ball joint suspension component and when the selected adapter member is attached to the threaded rod member, receives the selected adapter member and the threaded rod therein, and wherein an outer end of the threaded rod opposite the end at which the selected adapter member is attached is fastened relative to an end of the puller tube member opposite the end at the ball joint suspension component.

19. The kit of claim 18, wherein each of the plurality of adaptor members includes a first end and a second end, and wherein the first end of the adaptor member comprises a threaded portion for mechanical attachment to the threaded rod, and wherein the second end of the adaptor member comprises a threaded portion for mechanical attachment to the ball joint suspension component.

20. The kit of claim 19,wherein the threaded portions of the second ends of the plurality of adapters comprise different thread diameters and/or thread pitches corresponding to respective ones of different thread diameters and thread pitches for various all-terrain vehicle (ATV), side-by-side off-road vehicle or snowmobile universal ball joint suspension components.

21. The kit of claim 18, wherein each of the plurality of adaptor members includes a body portion having a first end and a second end, and wherein the first end of the adaptor member comprises a threaded portion for mechanical attachment to the threaded rod, and wherein a central portion of the body portion of the adaptor member includes a first aperture extending through the body portion of the adapter member comprising a clearance opening, and wherein the second end includes a second aperture for mechanical attachment to the ball joint suspension component.

22. The kit of claim 21, wherein the first aperture extends generally only part-way into the body portion of the adapter member comprising a clearance opening.

23. The kit of claim 21, wherein the second end aperture for mechanical attachment to the ball joint suspension component comprises a slotted through-opening.

24. The kit of claim 21, wherein the second end aperture for mechanical attachment to the ball joint suspension component comprises a circular through-opening.

25. A method of servicing a ball joint suspension of an all-terrain vehicle (ATV), side-by-side off-road vehicle or snowmobile via a universal ball joint installation and removal tool kit, said method comprising:
providing a slide hammer tool assembly comprising a slide hammer rod member, a slidable weight movably disposed at the slide hammer rod member and a handle, wherein the slide hammer rod member comprises a first end and a second end;
attaching the handle at the first end of the slide hammer rod member;
providing a plurality of adapter members configured for mechanical attachment or engagement with respective different sized ball joint suspension components;
selecting one of the adapter members for servicing a particular ball joint suspension;
attaching the selected adapter member at a ball joint suspension component of the particular ball joint suspension;
attaching the selected adapter member at the second end of the slide hammer rod member; and
sliding the slidable weight along the slide hammer rod member to install or remove the ball joint suspension component of the particular ball joint suspension.

26. The method of claim 25, wherein at least some of the plurality of adapter members comprise a threaded first end for threadedly attaching the selected adapter member at the second end of the slide hammer rod member and a threaded second end for threadedly attaching the selected adapter member at the ball joint suspension component of the particular ball joint suspension.

27. The method of claim 26, wherein the plurality of adapter members comprise adapter members having different size thread diameters and/or different thread pitches.

28. The method of claim 25, wherein providing a slide hammer tool assembly comprises providing a plurality of different length slide hammer rod members, and wherein said method comprises selecting one of the slide hammer rod members prior to attaching the handle at the first end of the slide hammer rod member.

29. The method of claim 25, wherein at least some of the plurality of adaptor members include a body portion having a first end and a second end, and wherein the first end of the adaptor member comprises a threaded portion for attachment to the second end of the slide hammer rod member, and wherein a central portion of the body portion of the adaptor member includes a first aperture extending through the body portion of the adapter member comprising a clearance opening, and wherein the second end includes a second aperture for mechanical attachment to the ball joint suspension component.

30. The method of claim 29, wherein attaching the adaptor member to the ball joint suspension component comprises receiving a threaded portion of the ball joint suspension component through the second aperture and attaching a fastener at the threaded portion of the ball joint suspension component to retain the ball joint suspension component at the second end of the adaptor member.
